(19) United States
(12) Patent Application Publication
(10) Pub. No.: US 2003/0021823 A1
(43) Pub. Date: Jan. 30, 2003

(54) Coated polymer material, its use and process for its production

(76) Inventors: Rudiger Landers, Freiburg (DE); Rolf Mulhaupt, Freiburg (DE); Hendrik John, Marl (DE)

Correspondence Address: EDWARDS & ANGELL, LLP., P.O. BOX 9169, BOSTON, MA, 02209, US

(21) Appl. No.: 10/180,244

(22) Filed: Jun. 26, 2002

(30) Foreign Application Priority Data
Jun. 27, 2001 (DE) 101 30 968.6

(51) Int. Cl. B05D 5/00

(52) U.S. Cl. 424/423; 427/243

(57) ABSTRACT

A coated polymer material having a swollen polymer network and a coating formed by reacting at least two reactants in the presence of the polymer material is provided, wherein the coating is obtainable by contacting the polymer material, which encloses the one reactant diffusibly, with the second reactant in liquid medium.

The invention relates to a coated polymer material, in which the coating is formed by reaction of at least two reactants in the presence of the polymer material. The invention also relates to uses and a process for producing the coated polymer material. Such a coated polymer material is particularly well suited as a substrate for living cells, for example for producing synthetic tissue, bone substance, organs or structures similar to organs and other constituents to be introduced into the human, animal or plant organism (“Tissue engineering”), also as an implant or as coatings of medical devices, such as stents, catheters or by-pass devices which are used in the human or animal body and the biocompatibility of which is to be improved.

It is generally known to modify polymer materials at the surfaces in order to give them certain properties or to furnish them with required functions. For medical applications, it is important to render biocompatible the surfaces of polymer materials, which are used for example in implants, via suitable surface coatings. Furthermore, in past years the importance of cell substrates and implants has increased considerably for the field of “Tissue Engineering”. On the polymer materials used for this, in addition to the required biocompatibility, particular claims are placed on the surface of the required structures. This usually requires a chemical or physical modification of the surface of the cell substrate or implant.

For this purpose, in the past a number of techniques have already been developed for metals and solid polymer materials. Plasma coating, photooxidation, plasma oxidation, photopolymerisation, covalent bonding to the material or even physical absorption should be emphasised here (see the example of surface-modified silicones: T. Okada and Y. Ikada, Journal of Biomedical Material Research, Volume 27, 1509-1518 (1993)). Alternatively, in cell culture technology, use is made of the effect that proteins present in solutions, such as for example fibronectin, denature during drying and form a stable film. Flat vessels may thus be coated (see for example I. A. M. Relou et al., Tissue & Cell, Volume 30, 525-538 (1998)). Drying of a gelling fibrinogen/thrombin mixture also acts similarly, wherein after drying there is a water-insoluble fibrin film (see. V. V. Nikolaychik et al., ASAIO Journal, Volume 40, M846-M852 (1994)).

However, purely physical absorption of the coating material on polymer materials is often associated with inadequate adhesion. What the reactive techniques have in common is the fact that either the material itself is changed (for example oxidation) or coating is effected by materials acting externally on the substrate to be coated.

In contrast to this, gels and hydrogels are swellable or swollen materials having a solids content between 1 and 50%, normally up to 15%. The swelling agent is thus water or a water-based system, the solid constituent a crosslinked polymer. The influence of the polymer on the biocompatibility of the hydrogel is thus indeed not so great as for the non-swollen materials, but still relevant. However, coatings are not only used for the purpose of biocompatibility, but also for reinforcing hydrogel layers and for the control of the barrier properties. In the technology of microencapsulation, the reaction of two different reactants with one another is often utilised for coating. In the known techniques, a reaction takes place between the polymer of the hydrogel and the externally added reactant, or purely physical absorption takes place on the hydrogel. The techniques developed for surface modification of solid materials, such as for example plasma oxidation, are usually unsuitable for hydrogels. Even drying of protein solutions cannot be carried out in the case of hydrogels, since they would lead to undesirable shrinkage of the hydrogel. Purely physical absorption is less stable. On the other hand for covalent bonding, the polymers must contain reactive groups. If this is not provided, or their reactivity is too low in aqueous medium, expensive modifications of the polymer have to be carried out in order to generate reactivity.

It is the object of the present invention to provide an improved coating system for swollen polymer materials.

This object is achieved by a coated polymer material having a swollen polymer network and a coating formed by reacting at least two reactants in the presence of the polymer material, wherein the coated polymer material is obtainable by contacting the swollen polymer material, which encloses the one reactant diffusibly, with the second reactant in liquid medium.

The object is also achieved in a further aspect of the invention by a process for producing a coated polymer material, in which the coating is formed by reacting at least two reactants in the presence of the polymer material, comprising the following steps:

a) providing a polymer material, which has a swollen polymer network and encloses the one reactant diffusibly and

b) contacting the polymer material with the second reactant in liquid medium, so that the reactants react with one another with formation of the coating.

It is particularly important for the coating being formed during the reaction that the polymer material encloses the one reactant diffusibly. In contact with the other reactant present in liquid medium, the reactant enclosed in the polymer material may diffuse at the phase boundary between the polymer material and the liquid phase and cause the reaction there with the other reactant. This concept can be applied very effectively to polymer materials which can be swollen. Mobility of the reactants which is favourable for the reaction is provided by the swelling agent. In principle, the concept can be applied to any swellable polymer materials of semi-solid, pasty or gel-like quality, but particular advantages result for the hydrogels which are traditionally difficult to coat. The property of swellable polymer materials, in particular those of the hydrogels, is thus utilised to have an optionally high storage capacity with respect to the one reactant. No special chemical requirements are placed on the polymer of the polymer material, provided it forms a polymer network in a corresponding matrix system, for example in a suitable swelling agent or a swellable binding system. A stable coating distributed essentially uniformly over the surface of the polymer material may be generated in controllable manner during the reaction by the quantity of the one reactant stored in the composition of the polymer material. A characteristic surface structure, which is very advantageous for cell adhesion and cell colonisation, is obtained by the diffusion processes going along with the reaction. A chemical change in the polymer matrix itself may indeed take place depending on the type of reactants selected, but is not necessary so that the polymer material substrate may remain fully intact. Carrying out coating according to the invention is comparatively quick and simple and requires only small quantities of substance.

The coated polymer material and the process which leads to obtaining the specially reacted coating, is illustrated in more detail below with reference to preferred embodiments and the attached figures.

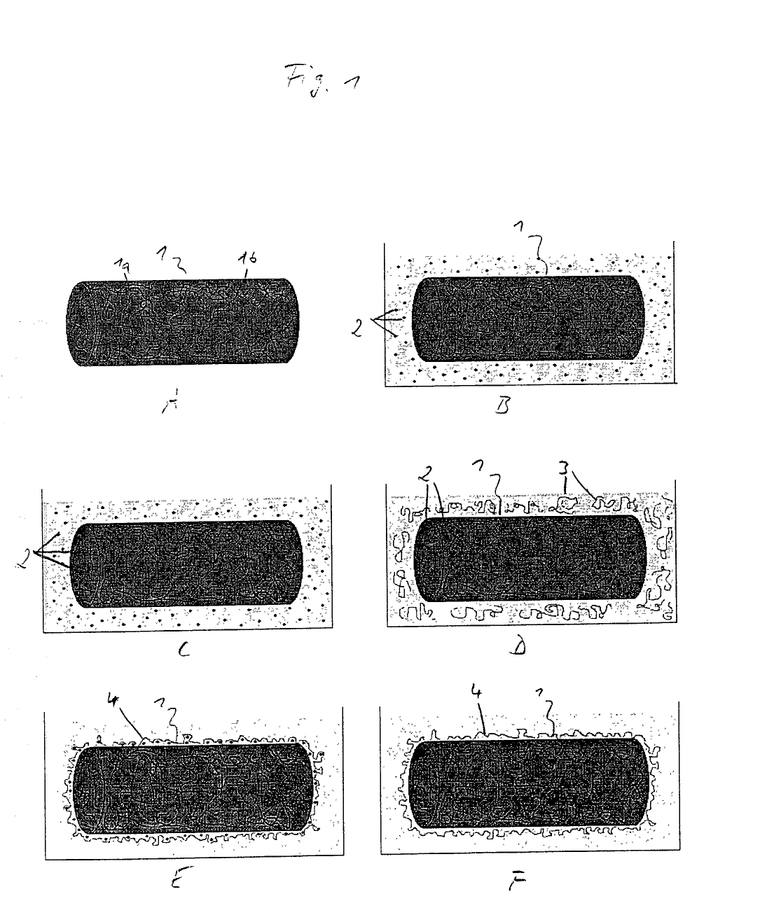

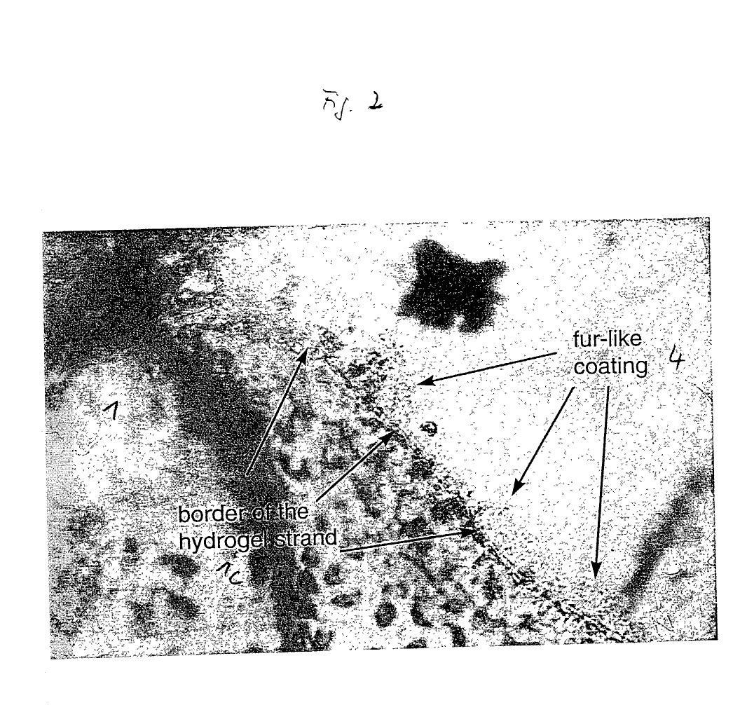

FIGS. 1A-1F show schematically the steps of the production of the coating of the invention according to one embodiment.

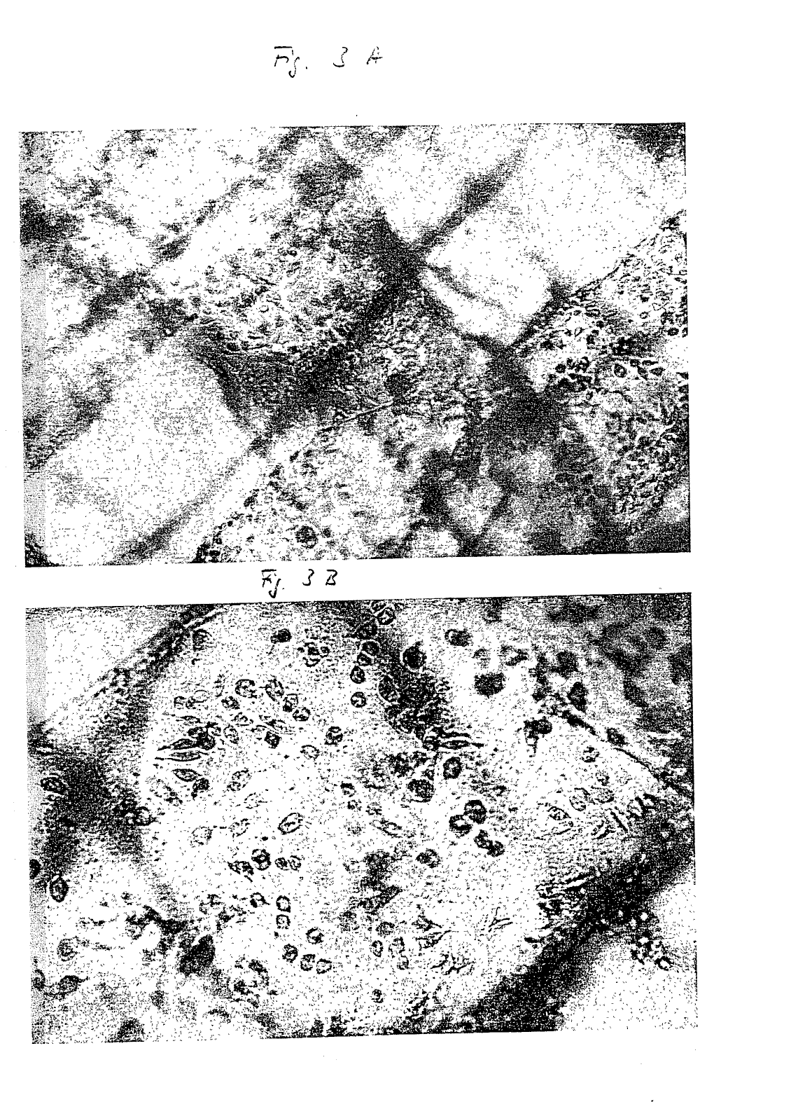

FIG. 2 shows the microscopic representation of the surface structure obtained during coating according to the invention according to one embodiment.

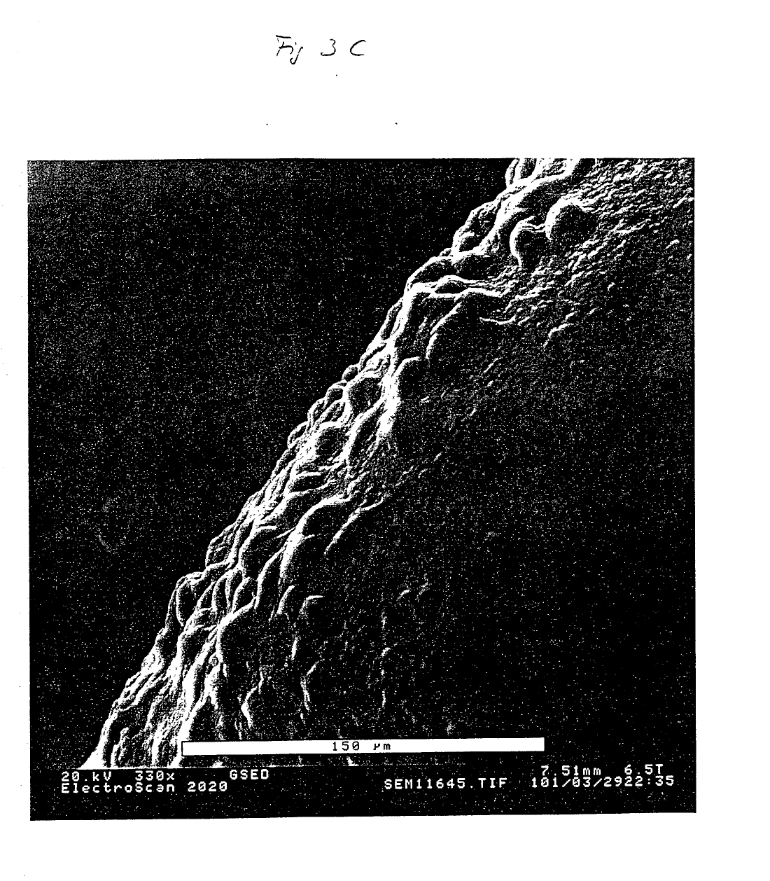

FIGS. 3A-3C show microscopic (FIGS. 3A and B) or electron-microscope (by means of ESEM, FIG. 3C) representations of polymer materials coated according to the invention as three-dimensional objects which support adherent cells.

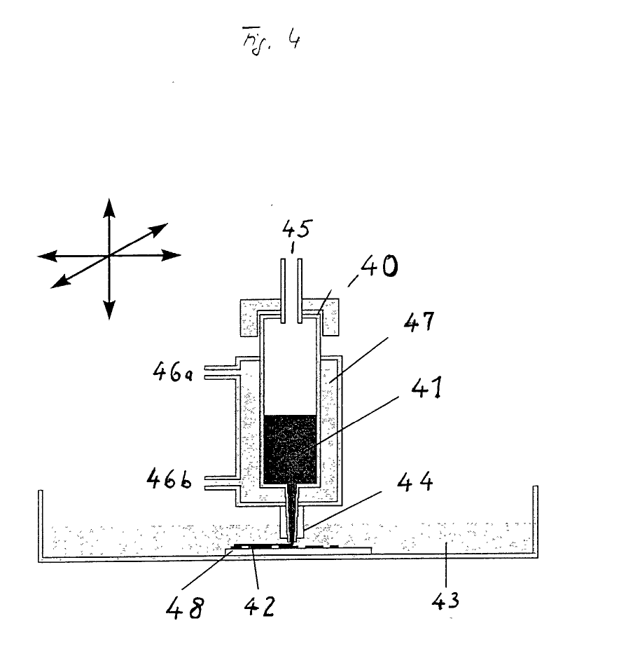

FIG. 4 shows schematically a device, with which, according to one preferred embodiment, polymer materials are provided for coating as three-dimensional objects by means of the 3D-plotting process.

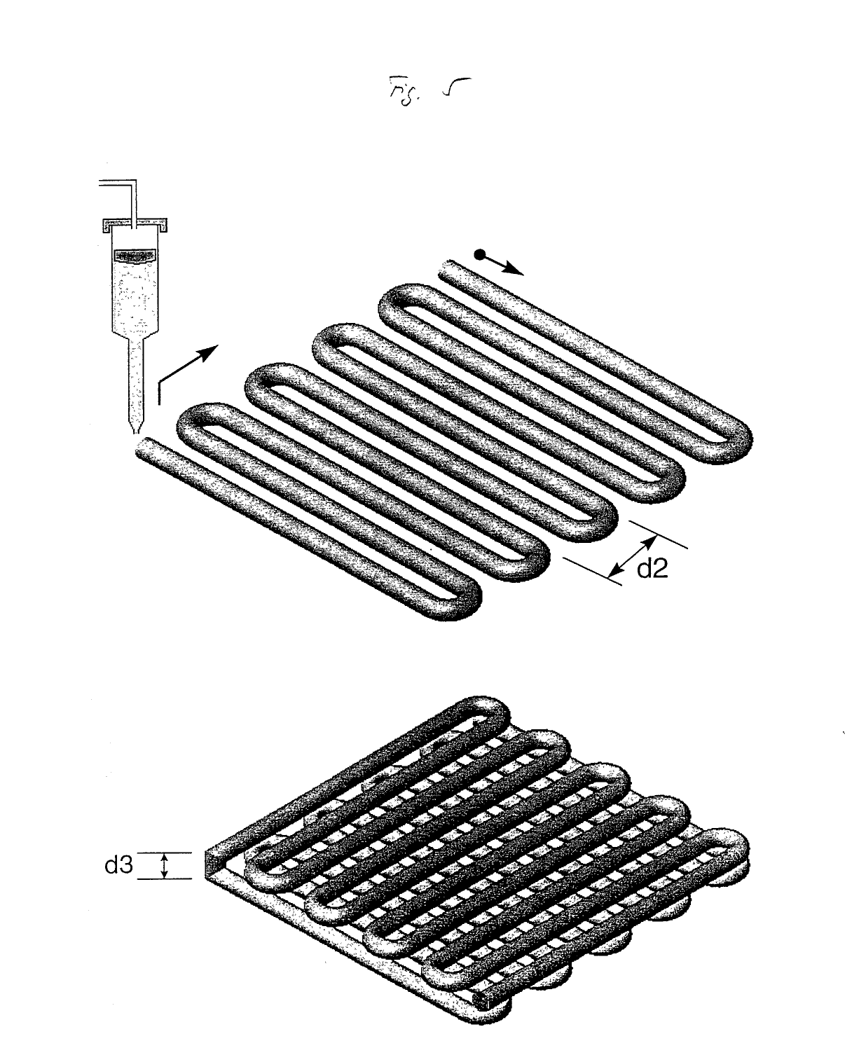

FIG. 5 shows schematically the production of a three-dimensional skeleton structure by the 3D-plotting process, as a result of which the polymer material is provided for coating according to the preferred embodiment.

The polymer material to be coated may exist in any shape and dimension required according to application, for example particulate, as foil or film, as a fibre strand or as a hollow fibre in bundled, woven or non-woven form, as a three-dimensionally shaped structure or the like. Preferred three-dimensional structures and processes for providing polymer materials as such objects are illustrated in more detail below.

The polymer material to be coated encloses the one reactant diffusibly. The substance of the first reactant is thus present in the polymer matrix to be as freely diffusible as possible. In order to guarantee good mobility and diffusibility, the substance of the first reactant preferably has a relatively low molecular weight, suitably a molecular weight of 50,000 at the most, preferably 10,000 at the most, also preferably 1,000 at the most, in particular 500 at the most and above all 100 at the most. The substance of the polymer material is at least partly, preferably largely and also preferably completely, charged with the substance of the first reactant. The quantity of substance charged or stored in the swollen polymer material is then introduced into the reaction with the second reactant during the subsequent reaction. For charging, the polymer material may be treated so that the first reactant diffuses or permeates into the polymer material or that it is drawn in, for example by immersing the polymer material in a solution of the first reactant for an adequate period. If possible in terms of process technology, alternatively the polymer material may already contain the first reactant enclosed, as a result of production, so that a separate step of charging is no longer necessary.

So that the subsequent reaction with the second reactant may proceed in as controlled a manner as possible, it is advantageous to subject the polymer material provided with the charged first reactant to a treatment in order to free the surface at least partly, better largely, of the enclosed first reactant, before contact with the second reactant takes place. This may be achieved most simply by single or repeated washing of the polymer material in the reactant-free medium.

Contacting the swollen polymer material charged with the first reactant with the liquid phase, which contains the further reactant in the form of a solution, dispersion or emulsion, then effects product formation between the reactants. The reaction starts and proceeds essentially on and/or in the vicinity of the phase boundary between the swollen polymer material and the liquid phase. Depending on the type of reactants and the reaction course, in particular the affinity and the mobility of the particular reactant with reference to the particular other phase, the coating may be constructed on the surface externally. However, a reaction may also take place, optionally additionally, in the swollen polymer material itself. These reaction courses resulting from diffusion processes on and/or in the vicinity of the phase boundary form the basis for a controllable reaction and good adhesion of the coating, possible according to the invention, with the swollen polymer material. As a result of the concept of the invention, it is possible that the coating is joined adhesively to the polymer material by the product of the reaction, but without the polymer matrix having to be chemically modified. The polymer network and the required shape of the polymer material thus remain largely intact. Nevertheless, the chemical modification of the polymer network may take place as a result of the reaction of the actual reactants, if this is required. Furthermore, the concept of the invention is not restricted to a reaction of two reactants. Further reactants may be used and for this purpose initially placed in the polymer material together with the first reactant or in the liquid phase together with the second reactant, but wherein reaction of the reaction participants only takes place in the contacting step.

As a result of the possibility provided by the concept of the invention, that a limited quantity of first reactant present in the polymer material participates in the reaction accompanied by diffusion processes, a homogeneous coating of the polymer material distributed essentially over the entire surface having at the same time irregular surface structure may be generated. This is of considerable advantage for many applications, in particular for excellent adhesion and colonisation of living cells. In addition, the required thickness of the coating may be adjusted well by influencing the reaction conditions, for example in a range from 1 to 50 μm, in particular in the range from 5 to 40 μm, which is favourable for the applications.

In a preferred embodiment, the coating of the present invention takes place on the basis of a water-based system. Accordingly, the swelling agent for the polymer network of the polymer material is water, an aqueous solution or a mixture of water with organic solvents. Furthermore, in this preferred embodiment, the at least two reactants are water-soluble and as a result of the reaction form a water-insoluble product. However in principle, depending of the type of polymer network, non-aqueous swelling agents, such as organic solvents, can also be used. Extension to non-aqueous systems favourably permits the variable use of further reactants, which more easily cause a reaction according to the concept of the invention in the non-aqueous system.

The concept of the invention can be applied most effectively when the polymer network is present as a gel or paste and above all when it is present as a hydrogel. The coating system of the invention can be realised most simply and effectively using the water-based hydrogels. Due to the high water content, hydrogels can be charged easily with hydrophilic substances, which are suitable as reactants, and the diffusion processes going along with the reaction may proceed rapidly. In addition, a number of polymer types may be made available not only as gels, but also in the form of hydrogels. The polymer network usually has hydrophilic groups in order to furnish the polymer with hydrophilic nature. The polymer network may be constructed by covalent linkages of the polymers, but also via electrostatic, hydrophobic and/or dipole/dipole interactions between individual segments of the polymer chains. The polymer network may be constructed to be three-dimensional or in the form of interpenetrating or semi-interpenetrating networks (IPN or SIPN). Furthermore, polymer substances existing as hydrogels per se may be chemically modified, for example in order to be able to influence the stability and the biodegradation via increased crosslinking density.

For example polysaccharides or polysaccharide derivatives, proteins or protein-like products, polyurethanes, polyurethane/polyureas or polyester-polyurethane/polyureas, silicones, anionic or cationic polyelectrolytes, poly(meth)acrylates or poly(meth)acrylic acid derivatives or combinations of the said substances, are suitable as substances, which are suitable for the formation of the swellable, polymer network.

Suitable polysaccharides are, for example alginic acid or alginate, agar-agar and/or cellulose and cellulose derivatives. Suitable cellulose derivatives are hydroxyalkylcellulose, for example hydroxymethylcellulose or hydroxypropylcellulose, and hydroxyalkylcellulose ethers. Preferred polysaccharide is alginic acid or alginate, in particular agar-agar.

Suitable proteins or protein-like products are, for example gelatines or swellable or acid-soluble collagen, in particular those which can form thermoreversible hydrogels or can be filled by pH changes. Suitable synthetic polymer materials are, for example polyvinyl alcohol, the aqueous solutions of which can be solidified by cooling to form a hydrogel.

Suitable poly(meth)acrylates or poly(meth)acrylic acid derivatives are, for example hydroxyalkyl(meth)acrylate, a poly(N-alkylacrylamide) having in each case short-chain alkyl group, such as methyl, ethyl, n-propyl or iso-propyl.

The polymer material to be coated, if required, may include further useful substances but which are not impaired or modified, preferably in their function, by the subsequent reaction of the reactants. Fillers, which may optionally be biodegradable, may be included to increase the strength. Furthermore, the polymer material to be coated may contain at least one pharmaceutically active and/or at least one biologically active substance. By including pharmaceutical substances, very efficient active ingredient excipients may be produced and be furnished with useful properties, for example for a delayed released of the active ingredient—caused by the coating of the invention, or for a target-directed treatment in the sense of “Drug Targeting”—caused by the selection of suitable substances for the coating, optionally used as second reactant. Further preferred examples of pharmaceutically/biologically active substances, which may be included, are growth factors and cytokines, which may promote synthetic tissue construction (“Tissue Engineering”) according to requirement. Furthermore, living cells, which may be of plant, animal and above all human origin, and may originate, for example from cell cultures, may advantageously be included in the polymer material to be coated for the purpose of “Tissue Engineering”. Hydrogels in particular, which may optionally contain suitable nutrient or culture media in the polymer matrix, are well suited for this purpose due to the lack of toxicity or low toxicity and the good ability to take up living cells.

The second reactant used in the liquid phase is selected in a preferred embodiment so that not only is the coating produced, but that with the aid of it, at the same time cell adhesion and/or the biocompatibility of the polymer material is promoted. For this purpose, a series of substances are available which may fulfil the required function(s) and at the same time may participate in a suitable reaction with the first reactant stored in the polymer material. Hence, the following may be used alone or in combination: proteins, such as for example collagen, elastin and keratins, preferably glycoproteins, such as for example fibrinogen, fibronectin and laminin, proteoglycans, mucopolysaccharides (glucosaminoglucans), such as hyaluronic acid (hyaluronan), heparin and chondroitin sulphate, polyuronides, such as for example alginic acid or alginate, mineral formers, such as for example phosphate or hydrogen phosphate or the derivatives of the said substances.

The use of fibrinogen is most preferable. After charging the polymer material with thrombin and calcium ions, this coating system leads to the formation of a solid fibrin layer with excellent adhesion to the polymer material substrate. This system may be further improved by using aprotinin as stabiliser together with the fibrinogen. The coating reaction may thus be better controlled.

The type of reaction proceeding for the formation of the coating depends primarily on the selection of reactants. Thus, for a required type of reaction, the reactants may be selected, for example so that polyelectrolyte complexing, chemical, enzymatic or biochemical crosslinking, precipitation, a reaction promoted by pH change, polymerisation (for example free-radical polymerisation of hydroxyethylmethacrylic acid) or a redox reaction, takes place as the reaction.

Possible embodiments of the coating reaction and examples of particular reactants are mentioned in Table 1 below:

TABLE 1

| | First reactant | Second reactant |
|---|---|---|
| Reaction type | (for charging) | (in liquid medium) |
| Polyelectrolyte | a) Multivalent cations, e.g. | a) Anionic polyelectrolyte, |
| complexing | Ca²⁺, Mg²⁺, Zn²⁺, Fe³⁺ or | e.g. alginic acid, |
| | Al³⁺, preferably Ca²⁺ | hyaluronic acid, |
| | b) Multivalent anions, e.g. | (meth)acrylic acid or salts |
| | (hydrogen) phosphate, etc. | thereof, etc. |
| | | b) Cationic |
| | | polyelectrolyte, e.g. |
| | | chitosan, polyethylene |
| | | imine, etc. |
| Enzymatic or | Thrombin + Ca²⁺ | Fibrinogen |
| biochemical | | |
| crosslinking | | |
| Precipitation | Soluble salts, e.g. | Proteins which denature, |
| | phosphates, sulphates (e.g. | optionally in the presence |
| | alum), carbonates | of multivalent cations, |
| | | such as Ca²⁺ |
| PH changes | a) Acid solution (e.g. | a) Hyaluronic acid and/or |
| | hydrochloric acid) | alginic acid, basic casein |
| | b) Alkaline solution (e.g. | solution |
| | sodium hydroxide | b) Chitosan or collagen |
| | solution) | |
| Redox | a) Oxidising agent | a) is oxidised and coated |
| reactions | b) Reducing agent, for | b) is reduced and coated, |
| | example thiosulphate | e.g. silver salt solution |
| | solution | (this coating prevents cell |
| | | adhesion as good as |
| | | completely and is |
| | | germicidal) |
| Polymerisation | Fe²⁺ solution | Aqueous solution of |
| | | hydroxyethyl-methacrylate |
| | | (HEMA) with hydrogen |
| | | peroxide as initiator |

The principle of the concept of coating according to the invention is described below by way of example using polyelectrolyte complexing with reference to FIGS. 1A to 1F:

First of all, an object having swollen polymer material 1, for example a hydrogel which comprises a polymer network 1a and a matrix of the swelling agent 1b, is provided (FIG. 1A). The object is then immersed in a solution of the first reactant 2, for example Ca ions as multivalent cation, (FIG. 1B), after which this first reactant may diffuse into the matrix of the polymer material (FIG. 1C). After an adequate period for as complete as possible charging of the polymer material with the first reactant, the object 1 is brought into contact with the second reactant 3, for example alginate and/or hyaluronate as polyelectrolyte, in liquid phase (FIG. 1D). In this phase, the first reactant diffuses relatively quickly to the phase boundary due to its high mobility and forms the reaction product there, which in the case of a complexed polyelectrolyte is water-insoluble and is precipitated as a stable coating 4 (see FIGS. 1E and F). The reaction proceeding at the surface can be followed easily under a light microscope.

FIG. 2 shows the result of such a coating (agar-agar hydrogel as polymer object; Ca ions as first reactant and alginate/hyaluronate as polyelectrolyte, produced according to Example 1 described below) using a microscopic image. A complete homogeneous coating of the polymer object 1 is present. The product of the reaction has been formed on and in the vicinity of the boundary surface 1c of the hydrogel and offers a guarantee for solid adhesion of the coating. Furthermore, a characteristic, irregular surface structure has been formed by the coating 4. It is assumed that this is caused by diffusion channels which are formed during the reaction.

The polymer material coated according to the invention is conventionally a three-dimensional object. The shape of the object may be designed, as already mentioned, according to requirement and application. Three-dimensional objects may advantageously be used as active ingredient excipient, in particular as cell substrates or implants in order to utilise the excellent biocompatibility achieved due to the coating and ability for adhesion with respect to living cells.

Suitable processes for producing required three-dimensional objects of polymer materials are, for example cast moulding, such as for example pastes or hydrogels cast for cartilage replacement, or layer formation of hydrogels for producing synthetic skin (see for example G. B. Stark et al., Biological Matrices and Tissue Reconstruction, Springer Publ., Berlin, 1998). There is often a need to form three-dimensional structures independently of shaping processes, for example in order to construct structures which are similar to organs or in order to obtain better substrates for cultivated cells. For this purpose, cell-inclusion techniques on the micrometer scale have been developed (see W. M. Kuhtreiber et al., Cell encapsulation technology and therapeutics, Birkhäuser, Boston, 1998). Furthermore, “Rapid Prototyping” (RP) technology offers a computer-assisted system for tailored generation of three-dimensional objects, in particular utilising the “Free Form Fabrication” (FFF) Process (see Wohlers Report 2000, Rapid Prototyping & Tooling State of the Industry, Annual Worldwide Progress Report, T. Wohlers, Wohlers Associates, Inc., Fort Collins, Colo., 2000; and E. Sachs et al., Journal of Engineering for Industry, Volume 144, 481-488 (1992)).

In a preferred embodiment of the invention, the three-dimensional polymer material object is formed by means of the so-called 3D-plotting process. This process has been described in German patent application No. 100 18 987.3 and by R. Landers and R. Mülhaupt in Macromol. Mater. Eng. 282, 17-22 (2000). The principle of a device which is suitable for temperature-dependent gelling, is shown in FIG. 4. A double-walled cartridge 47 was coupled to a thermostat having inputs and outputs 46a/46b in order to be able to set temperatures of up to 100° C. A dispenser 40 is equipped with an ejection opening 44, which may be designed to be insulating or with an electric heating element, and a device 45 for building up an excess pressure (for example compressed air). A gellable polymer solution is present in the chamber of the dispenser as the plotting material 41. Plotting of the polymer material is executed under suitable conditions of the applied pressure and the temperature in a non-gaseous, conventionally a liquid plotting medium 43. Relevant parameters for three-dimensional plotting are also the thermal behaviour of the plotting material, its viscosity, its tendency to swell in the plotting medium and its density. In the case of thermoreversible hydrogels, the temperature of the polymer plotting material 41 is set adequately above the gelling temperature of the hydrogel and that of the plotting medium 43 at a range below it. Gelling of the plotting material in the medium should be delayed for a short period as a function of the quantity of plotting material leaving the ejection opening, the rate of movement of the plotting head and the required thickness of the strand layer, in order to facilitate fusing with the strand layer lying thereunder. The medium 43 should have approximately the same density as the plotting material 41, in order to compensate gravitational forces, which may otherwise lead to collapse of the overhanging regions, by adequate buoyant forces. The medium 43 may be, for example an aqueous medium and contain suitable additives in order to adjust the viscosity and the density of the plotting medium. Diffusion of the polymer chains of the plotting material into the plotting medium should be prevented. This may be achieved by allowing gelling to proceed adequately quickly, or by selecting a plotting medium which is insoluble for the polymer.

Required three-dimensional object structures, such as skeletons made from hydrogel strands 42 on an auxiliary support 48, for example a sand-blasted metal plate, may be constructed in this manner. For this purpose, the plotting head of the dispenser can be moved three-dimensionally, as demonstrated by the arrow directions. As shown in more detail in FIG. 5, the strand path may be fixed by computer-controlled movement of the dispenser using a strand thickness, which lies for example in the range from 50 to 1,000 μm, preferably from 50 to 500 μm and also preferably from 100 to 200 μm, which depends primarily on the selected internal diameter of the ejection opening of the dispenser. The macropore size, that is the average size of the pores being formed between the strands, may be adjusted to a required value via the thickness of the polymer strands and via the repetition intervals d2 and d3 of the strand path to be fixed by the apparatus. In the sense of good cell colonisation and good supply of nutrients and removal of spent material, the average pore diameter of the macropores in the three-dimensional skeleton object is set to a range from 10 to 1,000 μm, preferably from 200 to 400 μm. It is also advantageous if the three-dimensional object has micropores having average pore diameter in the range up to 50 μm, for example from 10 to 50 μm and preferably from 25-40 μm. Such micropores may be produced easily in the system of the invention of swellable polymer materials by the extraction technique. For this, pore-formers, such as cholic acid or zein protein from maize, which are extracted or eluted before or after coating from the polymer material using a suitable solvent, for example 70% strength ethanol, are added to the polymer material by way of supplement.

The production of the three-dimensional shape may be effected before coating according to the invention. However, it is possible in the sense of better process economy, to design the 3D plotting process so that at the same time the coating reaction required according to the invention proceeds in one step with the plotting process. In this case, the first reactant is already present in the plotting material 41 shown in FIG. 4 and the second reactant of the intended coating reaction is already present in the liquid plotting medium 43. The additive selected for the plotting material does not need to fulfil the function of the second reactant at the same time, but may do so.

Before the required cell colonisation, the object coated according to the invention should be sterilised, for example by treatment in 70% strength ethanol. In the case of using pore-formers, this may take place at the same time in one step with extraction. Before incubation with the cells to be colonised, the ethanol is removed by placing the object in culture medium.

FIG. 3A shows a part of a skeleton of a three-dimensional hydrogel with the coating of the invention. Adherent cells from a cell line, here fibroblasts, were adhered to this coating of the hydrogel with good efficiency. FIG. 3B shows a hydrogel strand adhered with the cells in a higher magnification.

FIG. 3C shows an electron-microscope image using an ESEM (“Environmental Scanning Electron Microscope”).

The invention is illustrated in more detail below using examples, but which should not restrict the invention.

### EXAMPLE 1

1. Production of the Polymer Material as Three-Dimensional Object

Three-dimensional substrates were produced by means of the technique of 3D-plotting as described in German patent application No. 100 18 987.3 and by R. Landers and R. Mülhlhaupt in Micromol. Mater. Eng. Volume 282, 17-22 (2000). A skeleton formed from a strand of the polymer material, as shown schematically in FIG. 5, was constructed using a 3D-plotter shown schematically in FIG. 4. The ejection opening of the 3D-plotter had a tip made from cyanoacrylate with an inner coating of PTFE (Teflon). The internal diameter of the ejection opening was 150 μm, the excess pressure exerted on the plotting material was 2.10×10⁵ Pa, and the rate of movement of the plotting head was 17.00 mm/s, wherein at the edges of the transition from one layer to the next layer lying thereabove, a delay period of 0.10 seconds was set. The repetition units d2 and d3 were 1.00 mm or 0.30 mm. 30 strand layers were constructed.

Thermoreversible hydrogels were produced as polymer materials. In Example 1, agar-agar was used as the material, which was plotted as 5 wt. % strength solution heated at 70° C. into a 4.5 wt. % strength, 20° C. cold gelatine solution. The metered agar strand solidified shortly after adhesion to the previous layer, as a result of which a porous 3D skeleton having a porosity of 35 to 45% was obtained.

2. Coating of the Polymer Material

The three-dimensional hydrogel substrate thus produced was initially placed in a 5M aqueous CaCl₂ solution for one hour. After diffusion of the Ca⁺⁺ ions into the hydrogel was completed, the object was washed three times rapidly using demineralised water and then placed in a solution which contained 0.01 g/l hyaluronic acid (sodium salt) and 0.01 g/l alginic acid (sodium salt). After adequate growth of the coating being formed by complexing the polyelectrolyte with the calcium ions, which can be followed well under a light microscope, the coating reaction was stopped by repeated rinsing with demineralised water.

The coating was distributed uniformly over the surface of the polymer strands. On the other hand, the surface quality, particularly in the region of the larger thicknesses, was irregular and “fur-like”. The thickness of the coating was between 5 and 40 μm.

3. Adhesion of Cells to the Coated Polymer Material

The three-dimensional skeleton thus coated was initially sterilised in 70% strength ethanol (three hours) and then placed in normal culture medium once again for three hours to remove the ethanol. Two cell types were sown onto the hydrogel skeletons, firstly a human osteosarcoma cell line (CAL-72) and secondly mouse fibroblasts (both cell types are available from DSMZ, Brunswick, Germany). Cultivation of the cells took place in depressions of microtitre plates in 100 μl of cell medium, wherein 1×10⁴ cells were introduced per depression. The medium for the fibroblasts consisted of RPMI 1640 (Gibco Life Technologies, Inc., Grand Island; N.Y., USA) with 5% foetal calf serum (FCS, PAA), 2% HEPES (Gipco Life) and the antibiotics Penicillin (100,000 U/l) and Streptomycin (100 mg/l) (both available from Seromed, Berlin, Germany). The medium for the osteosarcoma cell line consisted of Dulbecco-modified Eagles Medium (DMEM, Gibco Life) with 10% foetal calf serum, 2% HEPES, the antibiotic Penicillin (100,000 U/l) and Streptomycin (100 m/l) (both from Seromed) and the insulin/transferrin/sodium selenite culture additive (available from Sigma, St. Louis, USA). The cultivations took place for 48 hours in moist atmosphere with 5% CO₂ at 37° C. in an incubation chamber (Heraeus, Hanau, Germany).

The EZ4Y batch (available from Biomedica, Vienna, Austria) was used for the analysis of cell-proliferation ability and cytotoxicity. The basis of this test is the ability of living cells to convert the colourless or easily coloured tetrazolium salt by intercellular, intact reduction systems into the reduced, intensively coloured formazan. The quantities of developed colour, which can be determined by means of absorption at a wavelength of 540 nm, thus correlates with the number of living cells in a sample.

The investigations produced very good cell colonisation of the three-dimensional, coated substrate. The cell-colonisation efficiency with vital cells varied for both cell types between 20 and 35% of the originally used cells. These values are good for practical purposes in view of the short duplication times of the cells used (Fibroblasts: 24 hours, sarcoma cells: 50 hours).

### Comparative Example 1

Example 1 was repeated, but without coating the hydrogel polymer material with hyaluronate/alginate. The surface of the hydrogel was smooth as a result of production. In this case, after dropping the cell suspensions onto the 3D substrate, no adhesion of cells was observed (in contrast to bacteria, eukaryotic cells do not adhere easily to agar-agar). The cells sank through the pores of the skeleton.

### Comparative Example 2

Example 1 was repeated, but wherein instead of the coating of the invention, a coating was produced by casting a just-gelling fibrinogen-thrombin solution over the skeleton object.

As a result uniform coating was not achieved. In some cases the pores of the 3D substrate necessary for the perfusion of the nutrient medium were completely blocked, whereas the coating did not reach other points.

For Examples 2 to 9, thin discs of an agar hydrogel were subjected to the coatings described. Example 3 is therefore similar to Example 1.

### EXAMPLE 2

The objects made from hydrogel were immersed for 15 minutes in 1M CaCl₂ solution, rinsed 10× using demineralised water, and then immersed in a solution with 1 wt. % of alginate for coating.

The coating reaction proceeded very rapidly, and a solid and milky transparent coating was formed.

### EXAMPLE 3

The objects made from hydrogel were immersed for 15 minutes in 1M CaCl₂ solution, then rinsed 7× using demineralised water and then immersed for 2 minutes for coating in a solution which contained 0.25 wt. % of hyaluronate and 0.25 wt. % of alginate.

A milky, transparent coating was formed, which compared to Example 2 indeed had a somewhat lower strength, but better adhesion to the hydrogel object. Furthermore, lower shrinkage of the coating was shown compared to alginate alone. The coated hydrogel was well suited for cell cultures.

### EXAMPLE 4

The objects made from hydrogel were in a solution of thrombin and calcium (76 mg of trombin (bovine) and 59 mg of CaCl₂×2H₂O in 10 ml of isotonic NaCl solution), then rinsed 6× using demineralised water and then immersed for 5 minutes in a fibrinogen/aprotinin solution (870 mg of fibrinogen (bovine) and 1.6 mg of aprotinin in 20 ml of isotonic NaCl solution). The coating reaction proceeded rapidly and was easy to control. A white coating was formed with excellent adhesion to the hydrogel substrate, which did not show any shrinkage. The added aprotinin stabilised the fibrinogen and limited fibrin formation to the boundary between hydrogel and aqueous solution.

### EXAMPLE 5

The objects made from hydrogel were immersed for 15 minutes in alum solution (0.125 M potassium aluminium sulphate solution), rinsed 3× using demineralised water and then immersed for 5 minutes in 30 wt. % strength protein solution (hen's egg).

A solid coating of white, denatured protein was formed.

### EXAMPLE 6

The objects made from hydrogel were immersed for 15 minutes in 1 M hydrochloric acid solution, then rinsed 3× using demineralised water and then immersed for 5 minutes in a 30 wt. % strength protein solution (hen's egg).

A white coating with precipitating protein was formed. Adhesion with respect to the substrate was better compared to the use of alum according to Example 5.

### EXAMPLE 7

The objects made from hydrogel were immersed for 15 minutes in 1 M hydrochloric acid, rinsed 3× using demineralised water and then immersed for 5 minutes in 0.5 wt. % strength hyaluronic acid solution.

A transparent coating was formed which had good adhesion with respect to the substrate.

### EXAMPLE 8

The objects made from hydrogel were immersed for 15 minutes in 1 M HEPES solution, rinsed 3× using demineralised water and then immersed for 5 minutes in 1 wt. % strength collagen solution in hydrochloric acid (pH=2).

### EXAMPLE 9

The objects made from hydrogel were immersed for 15 minutes in 1 M CaCl₂ solution, rinsed 3× using demineralised water and then immersed for 3 minutes in 0.5 M Na₂PO₄ solution.

A coating of white precipitating calcium phosphate was developed very rapidly.

1. Coated polymer material having a swollen polymer network and a coating formed by reacting at least two reactants in the presence of the polymer material, which coated polymer material is obtainable by contacting the polymer material, which encloses the one reactant diffusibly, with the second reactant in liquid medium.

2. Coated polymer material according to claim 1, wherein contacting generates the product formation between the reactants on or in the vicinity of the phase boundary of the polymer material with the liquid medium, in which the second reactant is present.

3. Coated polymer material according to claim 1 or 2, wherein the at least two reactants are water-soluble and due to the reaction form a water-insoluble product.

4. Coated polymer material according to one of the preceding claims, wherein the coating is joined adhesively to the polymer material by the product of the reaction, without chemically modifying the polymer matrix.

5. Coated polymer material according to one of the preceding claims, wherein the coating is essentially homogeneous and at the same time has an irregular surface structure.

6. Coated polymer material according to one of the preceding claims, wherein the coating is 1-50 μm thick.

7. Coated polymer material according to one of the preceding claims, wherein it is a coated hydrogel or a coated gel.

8. Coated polymer material according to one of the preceding claims, which comprises as swollen polymer network, being swollen in aqueous medium, a polysaccharide or a polysaccharide derivative, a protein or a protein-like product, polyurethane, polyurethane/polyurea, polyester-polyurethane/polyurea, silicone, poly(meth)acrylate or poly(meth)acrylic acid derivatives or any combination of the said substances.

9. Coated polymer material according to claim 8, wherein the polysaccharide is selected from the group consisting of alginic acid or alginate, agar-agar, cellulose and cellulose derivatives.

10. Coated polymer material according to one of the preceding claims, wherein the one reactant enclosed in the polymer material diffusibly is a substance having molecular weight of 50,000 at the most, preferably of 10,000 at the most and in particular of 1,000 at the most.

11. Coated polymer material according to one of the preceding claims, wherein a substance is introduced into the coating, which promotes cell adhesion and/or biocompatibility, by the second reactant.

12. Coated polymer material according to claim 11, wherein the substance introduced is at least one substance which is selected from the group consisting of collagen, elastin, keratin, fibrin, fibronectin hyaluronic acid, heparin, chondroitin sulphate, casein, alginic acid and alginate or the derivatives of the said substances.

13. Coated polymer material according to one of the preceding claims, wherein the coating contains fibrin formed by the reactants thrombin and fibrinogen in the presence of calcium.

14. Coated polymer material according to one of the preceding claims, wherein the polymer material contains a pharmaceutically active substance, a biologically active substance or living cells.

15. Coated polymer material according to one of the preceding claims, wherein the polymer material forms a three-dimensional object.

16. Coated polymer material according to claim 15, wherein the three-dimensional object is formed by means of 3D-plotting.

17. Coated polymer material according to claim 15 or 16, wherein the three-dimensional object is a skeleton formed from fibres or strands.

18. Coated polymer material according to one of claims 15 to 17, wherein the three-dimensional object has macropores having average pore diameter in the range from 100 to 500 μm.

19. Coated polymer material according to one of claims 15 to 18, wherein the three-dimensional object has micropores having average pore diameter in the range up to 50 μm.

20. Use of a coated polymer material according to one of claims 1 to 19 as a cell substrate, as an implant or as a constituent of an implant or of a medical device incorporated in the human body.

21. Process for producing a coated polymer material, in which the coating is formed by reacting at least two reactants in the presence of the polymer material, comprising the following steps:
a) providing a polymer material, which has a swollen polymer network and encloses the one reactant diffusibly and
b) contacting the polymer material with the second reactant in liquid medium, so that the reactants react with one another with formation of the coating.

22. Process according to claim 21, in which the polymer material provided in step a) is largely charged with the one reactant, so that in step b) the reaction with the reactant stored in the polymer material takes place.

23. Process according to claim 21 or 22, in which the reaction in step b) takes place on or in the vicinity of the phase boundary of the polymer material with a solution, an emulsion or a dispersion of the second reactant.

24. Process according to one of claims 21 to 23, in which the polymer material in step a) is provided with an enclosed water-soluble reactant and in step b) is brought into contact with an aqueous solution, an emulsion or a dispersion of the second reactant, after which the reactants form a water-insoluble product.

25. Process according to one of claims 21 to 24, in which a substance having molecular weight of 50,000 at the most, preferably of 10,000 at the most and in particular of 1,000 at the most, is used as the reactant enclosed in the polymer material in step a).

26. Process according to one of claims 21 to 25, in which the polymer material provided in step a) was freed at its surface at least partly of the enclosed reactant, before the contacting step b) takes place.

27. Process according to one of claims 21 to 26, in which the reactants are selected such that polyelectrolyte complexing, crosslinking, precipitation, a reaction promoted by pH change, polymerisation or a redox reaction proceeds as the reaction.

28. Process according to one of claims 21 to 27, in which a three-dimensional object is used as the polymer material.

29. Process according to claim 28, in which the polymer material was prepared by a 3D-plotting process.

30. Process according to claim 28, in which the coating takes place at the same time in one step with a 3D-plotting process.

31. Process according to one of claims 21 to 30, in which the polymer material provided in step a) additionally contains enclosed pore-formers, which are extracted from the polymer material before or after coating.
